(19) United States
(12) Patent Application Publication
(10) Pub. No.: US 2009/0327234 A1
(43) Pub. Date: Dec. 31, 2009

(54) UPDATING ANSWERS WITH REFERENCES IN FORUMS

(75) Inventors: Greg Coladonato, Palo Alto, CA (US); Jim Deng, Sunnyvale, CA (US); Fan Jiang, Beijing (CN); Yizi Wu, Beijing (CN)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/163,437

(22) Filed: Jun. 27, 2008

(51) Int. Cl. G06F 17/30

(52) U.S. Cl. 707/3; 707/E17.014

(57) ABSTRACT

The present disclosure is directed to a system and method for updating answers with references in forums. In some implementations, a method includes presenting a media item including a question, a box for updating the media item with an answer, and a search field for entering a search query. In response to at least a search request entered in the search field, the search request is automatically executed with a remote search engine. A search result with an associated graphical element configured to update an answer to the question with a reference to the search result is presented. The answer including the search-result reference is automatically updated in response to at least a user selecting the associated graphical element.

### BACKGROUND

Content delivery over the internet continues to improve every day. Computer users can receive e-mail, news, games, entertainment, music, books, and web pages-all with a simple Internet connection (and with improved quality on a broadband connection). Internet users also have access to a plethora of services such as maps, shopping links, images, blogs, local search, satellite images, group discussions, hosted content, and e-mail. When an Internet user accesses these respective services, the content provided by the service is typically related to a particular topic that can, for example, be divided up into various content categories. By determining the category of content provided to an Internet user on a particular service, a service provider can give the Internet user questions and answers focused on the category, thus improving the user's experience.

### SUMMARY

The present disclosure is directed to a system and method for updating answers with references in forums. In some implementations, a method includes presenting a media item including a question, a box for updating the media item with an answer, and a search field for entering a search query. In response to at least a search request entered in the search field, the search request is automatically executed with a remote search engine. A search result with an associated graphical element configured to update an answer to the question with a reference to the search result is presented. The answer including the search-result reference is automatically updated in response to at least a user selecting the associated graphical element.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an example reference system for associating additional information with posted answers to questions accessible online;

FIGS. 2A to 2D illustrate example Question and Answer (Q&A) Web pages including embedded references; and

FIG. 3 is a flow chart illustrating an example method for embedding references in answers in Q&A Web pages.

Like reference symbols in the various drawings indicate like elements.

### DETAILED DESCRIPTION

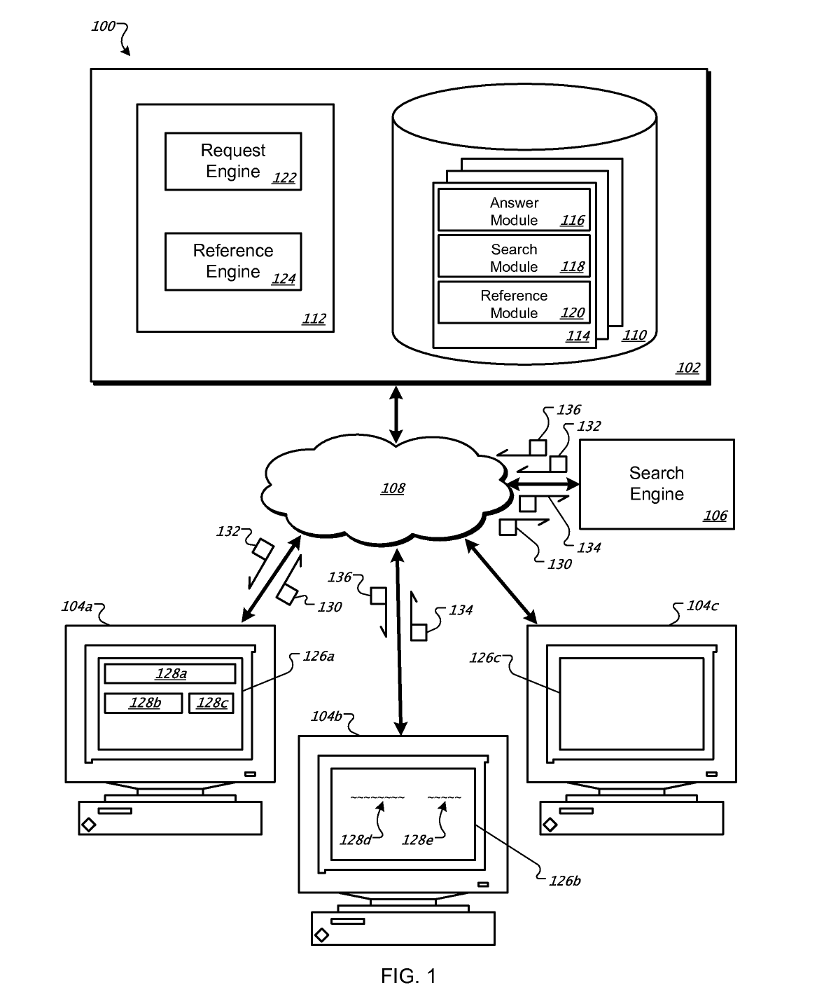

FIG. 1 is a block diagram illustrating an example reference system 100 for providing references in answers to posted questions. For example, the system 100 may embed footnotes and an associated search query in an answer to a posted question such that the footnotes may be configured to allow for retrieval of content and the embedded search query is configured to automatically execute the search query. In some implementations, embedded references can include a hyperlink to, for example, Websites, images, videos, blogs, news, books, maps, Uniform Resource Locators (URLs) and/or other searchable content. An embedded search query may include a URL to a search engine and text for executing the search. Individuals frequently post questions in, for example, online forums to solicit advice and/or other information from users. By enabling a user to embed references and search queries, the system 100 may easily provide authorities for answers to questions and/or expertise in formulating search queries for questions. In some implementations, the system 100 may execute one or more of the following: present a search field configured to execute searches in connection with an answer box; present search results to the user including graphical elements configured to embed a reference to the search results and/or the corresponding search query in the answer; update associated Question and Answer (Q&A) Web pages with answers, one or more references, and/or search queries; present the Q&A Web pages with a question, an answer, a reference, and/or a search query that was initially used to identify the reference; automatically execute a search query associated with a reference in an answer in response to at least a user selecting the presented search query; present search results of the automatically executed search query to the user; and/or other processes. For example, the system 100 may embed footnotes to search results in posted answers and automatically execute search queries that were initially used to identify the search results in response to a user, for example, clicking a single graphical element. In this example, the system 100 may illustrate more effective search-query formulations than queries previously executed by the user. In other words, the system 100 may facilitate transmission of search expertise from more knowledgeable users to less knowledgeable users.

At a high level, the system 100 includes a forum server 102, clients 104a-c, and a search engine 106 coupled through a network 108. The forum server 102 includes memory 110 and a processor 112. The memory 110 locally stores a plurality of Q&A Web pages 114 for presenting questions, answers, and references to content associated with the answers. The Q&A Web pages 114 include an answer module 116 for submitting answers to posted questions, a search module 118 for executing search queries and embedding references and/or corresponding search queries in posted answers, and a reference module 120 for presenting at least one reference to a search result (e.g., hyperlink) and a corresponding search query and executing the search queries in response to a request. The processor 122 includes a request engine 122 for providing Q&A Web pages 114 to the clients 104a-c in response to at least a request and an update engine 124 for updating the Q&A Web pages 114 with answers and embedding the reference module 120. The clients 104a-c include Graphical User Interfaces (GUIs) 126a-c configured to present graphical elements 128a-d. The search engine 106 identifies search results (e.g., Websites, images) in response to search requests submit using the search module 118.

In one example implementation, the request engine 122 may receive a request for the Q&A Webpage 114 and transmits the Q&A Webpage 114 to the client 104 for display through the GUI 126. In response to at least a request to submit an answer, the answer module 116 may present an answer box 128a and an associated search field 128b with a submit button 128c. The search module 118 may automatically transmit a search query 130 to the search engine 106 submitted using the search field 128b and the submit button 128c. Based, at least in part, on the search query 130, the search engine 106 may transmit search results 132 to the client 104a. The client 104a may present the search results 132 to the user through the GUI 126a including graphical elements for updating an answer with a reference (e.g., footnote) to a search results. In response to at least a user updating a Q&A Webpage 114 with an answer and a reference, the client 104a transmits the answer, the reference and the search query to the server 102. The update engine 124 automatically updates the associated Q&A Webpage 114 with an embedded reference module 120 based, at least in part, on the received answer, reference, and search query. In connection with a client 104b subsequently receiving the updated Q&A Webpage 114, the client 104b may present the Q&A Webpage 114, the question, the answer, the reference 128d and the associated search query 128e. In response to at least a user selecting the search query 128, the search query 128 automatically transmits a search request 134 to the search engine 106 for execution. The client 104b presents the search results 136 to the user through the GUI 126b.

Turning to a more detailed description of the elements, the server 102 comprises an electronic computing device operable to receive, transmit, process and store data associated with system 100. System 100 can be implemented using computers other than servers, as well as a server pool. Indeed, the forum server 102 may be any computer, electronic or processing device such as, for example, a blade server, general-purpose personal computer (PC), Macintosh, workstation, Unix-based computer, or any other suitable device. In other words, system 100 may include computers other than general purpose computers as well as computers without conventional operating systems. The forum server 102 may be adapted to execute any operating system including Linux, UNIX, Windows Server, or any other suitable operating system. In certain implementations, the forum server 102 may also include or be communicably coupled with a web server and/or a mail server.

The forum server 102 includes the memory 110 and the processor 112. Memory 110 may be a local memory and include any memory or database module and may take the form of volatile or non-volatile memory including, without limitation, magnetic media, optical media, random access memory (RAM), read-only memory (ROM), removable media, or any other suitable local or remote memory component. In the illustrated implementation, the memory 110 includes the Q&A Web pages 114, but may include other information without departing from the scope of this disclosure. Local memory 110 may also include any other appropriate data such as applications or services, firewall policies, a security or access log, print or other reporting files, HTML files or templates, data classes or object interfaces, child software applications or sub-systems, and others.

The Web pages 114 comprise displays through which questions and associated answers can be presented to users of the clients 104. In general, the Web pages 114 include any machine readable and machine storable work product that may generate or be used to generate a display through GUI 126. The Web pages 114 may be a file, a combination of files, one or more files with embedded links to other files, or any other suitable configuration. The Web pages 114 may include text, audio, image, video, animation, and other attributes. In short, Web pages 114 comprise any source code or object code for generating a display that presents questions, enables users to submit answers and embed references and search queries. The Web page 114 may be written in or based on any suitable programming language such as JavaScript. In the illustrated implementation, the Web page 114 includes the answer module 116, the search module 118 and the reference module 120. The answer module 116 can include any software configured to enable users to submit answers to posted questions. For example, the answer module 116 may present an answer box 128a to a user in response to at least a request to post an answer to a question. In some implementations, the answer module 116 may execute one or more of the following: receive a request to update a Web page 114 with an answer to a posted question; generate a field (e.g., an answer box 128a) for the user to submit text; receive an indication to update the Web page 114 with an answer and any references; transmit a request to update the Web page 114 to the server 102; and/or other functions. In some implementations, the answer module 116 may receive an update request in response to at least a user selecting, for example, an answer button. In regards to presenting an answer field, the answer module 116 may present the answer box 128a in a separate Web browser. In connection with a user entering text and one or more references in the presented answer field, the answer module 116 may receive an indication to update the Web page 114 in response to at least a user selecting a submit button presented in connection with the answer field. As further discussed below, the insertion of the references and/or search queries can be facilitated using buttons and/or additional fields that enable a user to perform a search from an answer entry page and automatically or selectively insert information from search results, a particular search result, and/or the search query used to obtain such results. In response to at least an indication from the user to update the Web page 114, the answer module 116 may transmit a request to the server 102 to update the Web page 114 with the answer, any references and corresponding search queries.

The search module 118 can include any software configured to enable users to execute search queries in connection with submitting answers to posted questions. For example, the search module 118 may present the search field 128b and the submit button 128c in connection with presenting the answer box 128a and automatically execute a search request 130 in response to at least a user submitting a query using the field 128b and the button 128c. In some implementations, the search module 118 may execute one or more of the following: present a search field 128b in connection with presentation of an answer field 128a; receive a request to execute a search query based on text entered in the search field 128b; automatically transmit a search request 130 to the search engine 106; present search results 132 to the user including a graphical element for updating an answer with one or more of the results; automatically or selectively updating an answer with reference to a search result in response to an indication from the user; automatically or selectively updating an answer with a search query executed to identify the references; and/or other functions. In some implementations, the search module 118 can present the search field 128b and a submit button 128c in a same browser with the answer field 128a. For example, the search module 118 may present the search field 128b and a submit button 128c adjacent the search field 128a. In response to at least a user selecting the submit button 128c, the search module 118 may generate a search query based, at least in part, on text included in the search field 128b and transmit the search query 130 to the search engine 106 for execution. In some implementations, the search module 118 may use an Application Program Interface (API) to execute the search query. For example, the search module 128 may trigger AJAX calls to a remote backend to retrieve data with a corresponding AJAX search API, other API, and/or other elements. The search module 128 may present the search results 132 to the user in a Web browser different from the search field 128b. In some implementations, the search module 128 can present a graphical element (e.g., graphical button) for each of at least a subset of the search results such that the graphical element is configured to update an answer with a reference to the corresponding search result. For example, the search module 128 may update an answer with a footnote having a hyperlink to a search result in response to, for example, a user selecting an “Add” button. In connection with embedding references in the answer, the search module 128 may embed search queries executed to identify the one or more references.

Reference module 120 can include any software configured to automatically execute a previously-executed search query in connection with presenting answers and references. For example, the reference module 120 may execute a previously-executed search query associated with a search result referenced in an answer in the Web page 114. In addition, the reference module 120 may embed references in the Web page 114 to search results previously identified. In some implementations, the reference module 120 may execute one or more of the following: present a reference to a previously-identified search result in an answer; present in the answer a search query executed to identify the reference; automatically generate a search request 134 in response to at least a user selecting the presented search query; present the search results to the user; and/or other processes. In some implementations, the reference module 120 may present the search query using a graphical element such as the search query 128e in a posted answer. For example, the reference module 120 may present the search query used to identify a corresponding search result referenced in an answer. In other words, the reference module 120 may identify the search query used to identify a reference in an answer and automatically execute the search query in response to a user selecting the search query 128e. In some implementations, the search query 128e can include a hyperlink to the search engine 106 and text for identifying the query.

Processor 112 executes instructions and manipulates data to perform operations of the server 102. Although FIG. 1 illustrates a single processor 112 in the server 102, multiple processors 112 may be used according to particular needs, and reference to processor 112 is meant to include multiple processors 112 where applicable. In the illustrated implementation, the processor 112 executes the request engine 122 and the embedding engine 124 at any appropriate time such as, for example, in response to a request or input from a user of the server 102 or any appropriate computer system coupled with network 108.

The request engine 122 can include any software, hardware, and/or firmware configured to transmit a Web page 114 to a client 104 in response to at least a request. For example, the request engine 122 may receive a request identifying a specific Web page 114 and transmit the requested Web page 114 to the client 104 based, at least in part, on the request. In some implementations, the request engine 122 may execute one or more of the following: receive a request from a client 104 through the network 108; identify one or more parameters based, at least in part, on the request; transmit the requested Web page 114 to a client 104 in accordance with the parameters; and/or other processes. In some implementations, the request engine 122 may identify an identifier for a Web page 114 and a network address for the client 104 based, at least in part, on the request. The identifier may include a string unique to the Web page 114, a topic of the Web page 114, and/or other information. In some implementations, the request engine 122 may identify a network address included in the request. In some implementations, the request engine 122 may map a user identified in the request to the network address locally stored on the server 102.

The embedding engine 124 can include any software, hardware, and/or firmware configured to embed one or more reference modules 120 in the Web pages 114. For example, the embedding engine 124 may receive a request to update a Web page 114 with an answer, one or more references, and corresponding search queries and automatically update the Web page 114 with the answer and associated reference modules 120 based, at least in part, on the request. In some implementations, the embedding engine 124 may execute one or more of the following: receive a request to update a Web page 114 with an answer, references, and search queries; identify the answer, the one or more references and the search queries based, at least in part, on the request; update the Web page 114 with the answer; generate one or more reference modules 120 based, at least in part, on the included references and/or search queries; update the Web page 114 with the reference modules 120 in connection with including the answer; and/or other processes. In some implementations, the embedding engine 124 may identify text for the answer. In some implementations, the embedding engine 124 may identify one or more of the following associated the references: titles; content names; URLs; corresponding search queries; hyperlinks; [Please add any additional information used to embed the references and the search query in the Web page] and/or other information. In connection with embedding a reference, the embedding engine 124 may update the Web page 114 with a hyperlink to the corresponding content. In connection with embedding a search query used to identify the reference, the embedding engine 124 may generate a graphical element (e.g., search query 128e) configured to automatically execute the search query in response to a user selecting the element. In some implementations, the search-query element may include a hyperlink with text identifying the previously-executed search query. While FIG. 1 illustrates a single reference module 120 for embedding both the references and the search query, the embedding engine 124 may generate a different module for each reference and/or for each previously-executed search query.

Regardless of the particular implementation, “software,” as used herein, may include software, firmware, wired or programmed hardware, or any combination thereof as appropriate. Indeed, the request engine 122 and the embedding engine 124 may be written or described in any appropriate computer language including C, C++, Java, J#, Visual Basic, assembler, Perl, any suitable version of 4GL, as well as others. It will be understood that while the request engine 122 and the embedding engine 124 are illustrated in FIG. 1 as including individual modules, each of the request engine 122 and the embedding engine 124 may include numerous other sub-modules or may instead be a single multi-tasked module that implements the various features and functionality through various objects, methods, or other processes. Further, while illustrated as internal to server 102, one or more processes associated with the request engine 122 and/or the embedding engine 124 may be stored, referenced, or executed remotely. Moreover, the request engine 122 and/or the embedding engine 124 may be a child or sub-module of another software module or enterprise application (not illustrated).

Clients 104a-c are any devices (e.g., computing devices) operable to connect or communicate with the server 102, the search engine 106 or network 108 using any communication link. Each client 104 includes, executes, or otherwise presents a Graphical User Interface (GUI) 126 and comprises an electronic device operable to receive, transmit, process and store any appropriate data associated with system 100. While the illustrated implementation includes clients 104a-c, system 100 may include any number of clients 104 communicably coupled to the server 102. Further, “client 104” and “user” may be used interchangeably as appropriate. Moreover, for ease of illustration, each client 104 is described in terms of being used by one user. But many users may use one device or that one user may use multiple devices.

As used in this disclosure, a user of client 104 is any person, department, organization, small business, enterprise, or any other entity that may use or request others to use system 100. Client 104 is intended to encompass a personal computer, touch screen terminal, workstation, network computer, kiosk, wireless data port, smart phone, personal data assistant (PDA), one or more processors within these or other devices, or any other suitable processing or electronic device used by a user viewing content from the server 102. For example, the client 104 may be a PDA operable to wirelessly connect with an external or unsecured network. In another example, the client 104 may comprise a laptop that includes an input device, such as a keypad, touch screen, mouse, or other device that can accept information, and an output device that conveys information associated with question and answer posted using the server 102, including digital data, visual information, or GUI 126. Both the input device and output device may include fixed or removable storage media such as a magnetic computer disk, CD-ROM, or other suitable media to both receive input from and provide output to users of clients 104 through the display, namely the client portion of GUI 126.

The GUI 126 comprises a graphical user interface operable to allow the user of the client 104 to interface with at least a portion of system 100 for any suitable purpose, such as viewing Q&A Web pages. Generally, the GUI 126 provides the particular user with an efficient and user-friendly presentation of data provided by or communicated within system 100. The GUI 126 may comprise a plurality of customizable frames or views having interactive fields, pull-down lists, and buttons operated by the user. For example, the GUI 126 is operable to display certain network ads 118 in a user-friendly form based on the user context and the displayed data. The GUI 126 can be configurable, supporting a combination of graphical elements (e.g., fields, buttons), to present the Web pages 114 including the graphical elements 128. The term graphical user interface may be used in the singular or in the plural to describe one or more graphical user interfaces and each of the displays of a particular graphical user interface. The GUI 126 may be any graphical user interface, such as a generic web browser or touch screen, that processes information in the system 100 and efficiently presents the results to the user. The server 102 can accept data from the client 104 via a the web browser (e.g., Microsoft Internet Explorer or Netscape Navigator) and return the appropriate HTML, XML, and/or other responses to the browser using the network 108, such as the graphical elements 128.

The graphical elements 128 may include any graphical elements that present interactive elements to the user of the client 104. For example, the graphical elements 128 may execute a search query in connection with a user submitting an answer to a posted question and embed the answer with selected references. In some implementations, the graphical elements 128 may enable a user to identify a search previously executed to answer a question and automatically execute the search query with, for example, a single click. The graphical elements 128 may include one or more of the following: text, color, sound, hyperlinks, buttons, fields, and/or any other suitable electronic element. For example, the fields 128 may receive text submitted by a user to execute a search in connection with answering a question and buttons 128 for embedding a search result in an answer. In addition or alternatively, the graphical elements 128 may include text identifying a previously-executed search corresponding to the referenced content.

Network 108 facilitate wireless or wireline communication between the server 102 and any other local or remote computer, such as clients 104. Network 108 may be all or a portion of an enterprise or secured network. While illustrated as single network, the network 108 may be a continuous network logically divided into various sub-nets or virtual networks, so long as at least portion of the network 108 may facilitate communications of answers and references between the server 102 and at least one client 104. In some implementations, the network 108 encompasses any internal or external network, networks, sub-network, or combination thereof operable to facilitate communications between various computing components in the system 100. The network 108 may communicate, for example, Internet Protocol (IP) packets, Frame Relay frames, Asynchronous Transfer Mode (ATM) cells, voice, video, data, and other suitable information between network addresses. The network 108 may include one or more local area networks (LANs), radio access networks (RANs), metropolitan area networks (MANs), wide area networks (WANs), all or a portion of the global computer network known as the Internet, and/or any other communication system or systems at one or more locations.

In one aspect of operation, the request engine 122 may receive a request for a Q&A Webpage 114 based on one or more parameters. For example, the request may identify a topic, a specific page 114, a question, and/or other information. In response to at least the request, the request engine 122 identifies the Q&A Webpage 114 and transmits the Q&A Webpage 114 to the client 104 for display through the GUI 126. As previously discussed the transmitted Webpage 114 may include the answer module 116, the search module 118, and the reference module 120. In response indicating a request to submit an answer, the answer module 116 may present an answer box 128a as well as the search field 128b and the search button 128c. In some implementations, the search module 118 may present the search field 128b and the search button 128c proximate the answer box 128a. In some examples, the search field 128b and the search button 128c may be present in a same Web browser and a different Web browser presenting the Web page 114. In response to a user selecting the search button 128c and entering text in the search field 128b, the search module 118 may automatically transmit a search query 130 to the search engine 106. After receiving the search results 132, the client 104a may present the search results 132 using the GUI 126a and may also present graphical elements (e.g., buttons) for embedding references in an answer. In response to at least a user submitting an answer with embedded references, the client 104a transmits the answer, the reference and the search query to the server 102. The update engine 124 automatically updates the associated Q&A Webpage 114 with an embedded reference module 120 based, at least in part, on the received answer, reference, and search query. After a Web page 114 is embedded with references and search queries, a subsequent user may present the Q&A Webpage 114, the question, the answer, the reference 128d and the associated search query 128e. In response to at least a user selecting the search query 128e, the search query 128e automatically execute the identified search query and presents the search results 136 through the GUI 126.

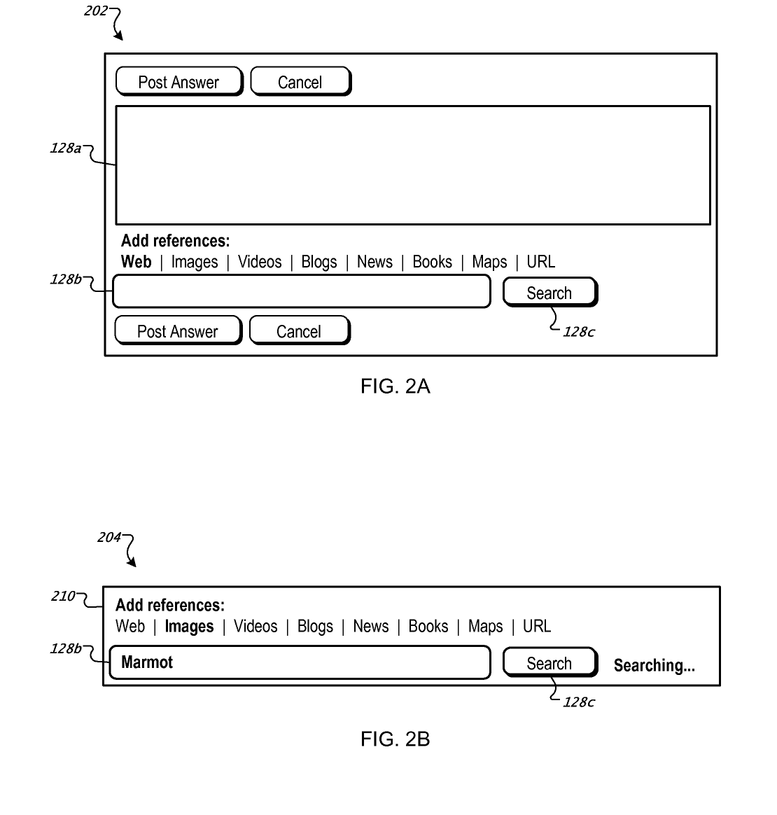

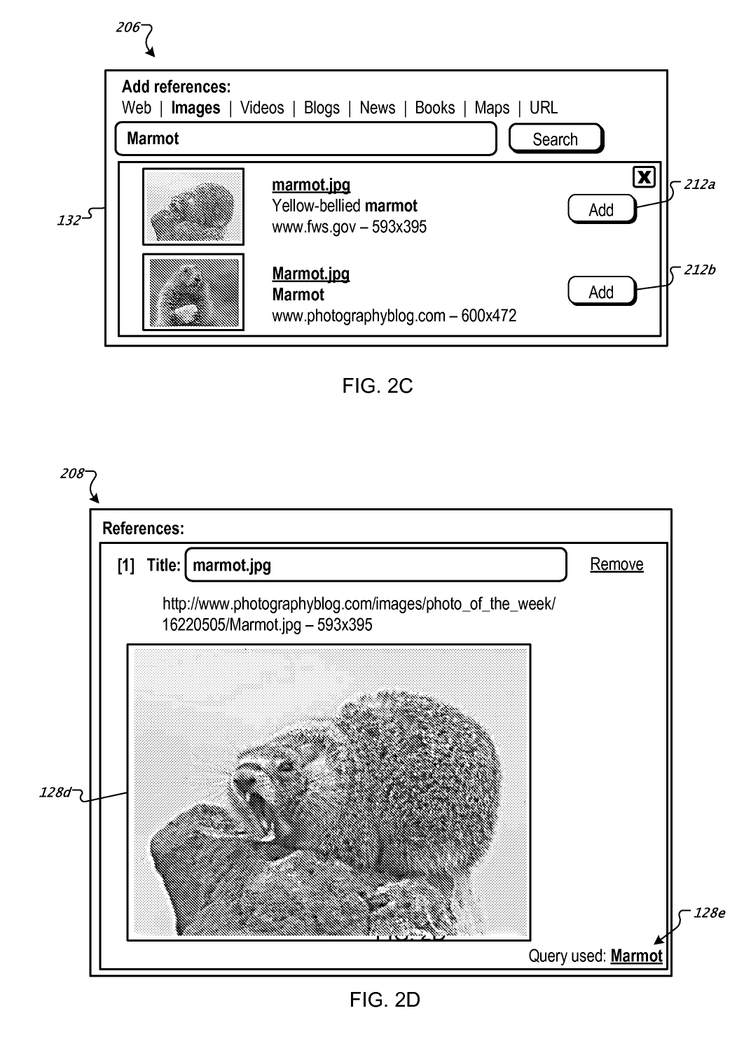

FIGS. 2A to 2D are example Web pages 202, 204, 206, and 208 including information associated with references embedded in posted answers. The illustrated page is for example purposes only, and the Web pages 202, 204, 206, and 208 may include some, all, or different information. Accordingly, the GUI 126 may present answers and embedded references, in any format or descriptive language and each page may present any appropriate answers and references in any layout.

Referring to FIG. 2A, the Web page 202 presents an answer box 128a, a search field 128b and a search button 128c in single Web page 202 for use in answering a posted question. For example, the answer module 116 may present the answer box 128a in a separate browser from the Web pages 114, and the search module 118 may present the search field 128b and the search button 128c in the same browser proximate the answer box 128a. Referring to FIG. 2B, the Web page 204 includes the search field 128b, the search button 128, and a search tab 210. Initially, the user may select a search topic by selecting one of the plurality of different search topics illustrated in the search tab 210 (e.g., images). The user may enter text in the search field 128b indicating a search query for execution (e.g., marmot). In response to a user selecting the submit button 128c, the search module 118 may automatically execute the search query in the search field 128b. Referring to FIG. 2C, the Web page 206 presents search results with each having an associated graphical element for embedding a reference in a posted answer. As illustrated, the search results 132 are presented to the user with corresponding add buttons 212 for embedding selected results in the answer. The search results can be presented to the user as part of the same Web page 206 that presents the answer box 128a. Referring to FIG. 2D, the Web page 208 illustrates a reference 128b embedded in an answer and a search query 128e for identifying the corresponding search query. In some implementations, the embedding engine 124 can embed both a search result and the previously-executed search query and present them through the Web page 208 using the reference 128b and the search query 128e, respectively. In this case, a user may view the content by selecting the reference 128d. In some implementations, the reference 128b is a hyperlink to a corresponding Web page. In some examples, a user may automatically execute the previously-executed search query by selecting the search query 128e. In some implementations, the search query 128e can be a hyperlink including text identifying the previously-executed search query.

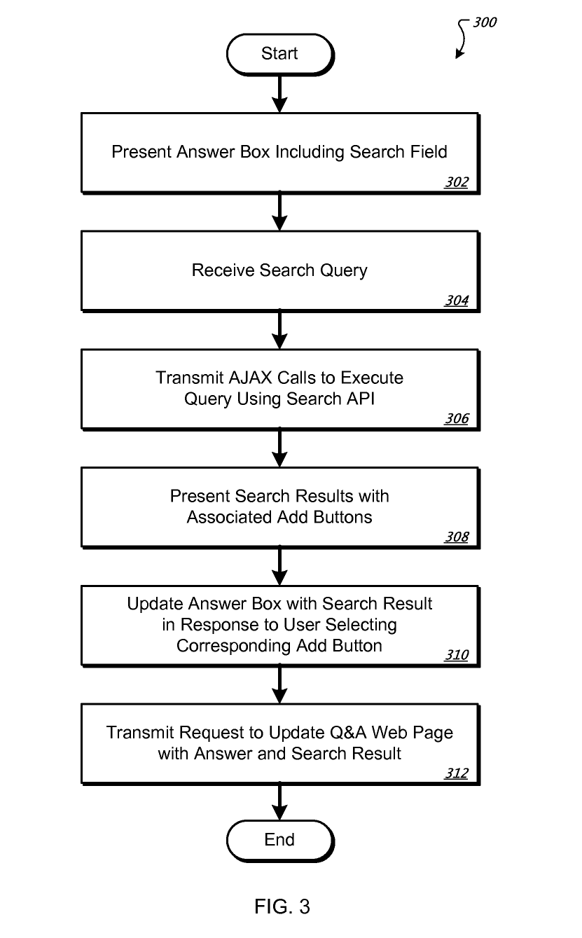

FIG. 3 is a flowchart illustrating an example method 300 for embedding search results and search queries in answers in accordance with some implementations of the present disclosure. Generally, the method 300 describes an example technique for executing a search query in connection with answering a posted question and automatically embedding the search result and the search query in the answer. Method 300 contemplates using any appropriate combination and arrangement of logical elements implementing some or all of the described functionality.

Method 300 begins at step 302 where an answer box including a search field are presented to a user. For example, the search module 118 of FIG. 1 may present the search field 128b and a search button 128c in a same browser as the answer box 128a (e.g., as part of the same window or within the same Web page). At step 304, a search query is received in connection with a user submitting an answer to a posted question. In the example, the search module 118 may receive a search query in response to at least a user entering the search query in the search field 128b and selecting the search button 128c. Next, at step 306, a call (e.g., AJAX) to execute the search query using a search API is transmitted. As for the example, the search module 118 may transmit an AJAX call to the search engine 106 to use a search API to execute the submitted search query. The search results with (e.g., associated) add buttons are presented to the user at step 308. Returning to the example, the search results 132 may be presented to the user with add buttons (e.g., buttons 202, buttons 304) for each result such that a user may embed one or more references when submitting an answer to a posted question. At step 310, the answer box is updated with at least one search result and the corresponding search query, for example, in response to at least the user selecting the add button assigned to the search result. Again in the example, the search module 118 may automatically update the answer box 128a with the reference 128d and the search query 128e in response to the user selecting the add button 128c. Next, at step 312, a request to update the Q&A Webpage with the answer and reference is transmitted in response to at least the user indicating a request to submit an answer. In the example, the answer module 116 may automatically transmit to the update engine 124 a request to update the Web page 114 with the answer and embed the selected reference and corresponding search query.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions tangibly stored on a computer readable storage device for execution by, or to control the operation of, data processing apparatus. In addition, the one or more computer program products can be tangibly encoded in a propagated signal, which is an artificially generated signal, e.g., a machine-generated electrical, optical, or electromagnetic signal, that is generated to encode information for transmission to suitable receiver apparatus for execution by a computer. The computer readable storage device can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a cross-platform runtime environment, or a combination of one or more of them. In addition, the apparatus can employ various different computing model infrastructures, such as web services, distributed computing and grid computing infrastructures.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method, comprising:
presenting a media item including a question, a box for updating the media item with an answer, and a search field for entering a search query;
in response to at least a search request entered in the search field, automatically executing the search request with a remote search engine;
presenting a search result with an associated graphical element configured to update an answer to the question with a reference to the search result; and
automatically updating the answer including the search-result reference in response to at least a user selecting the associated graphical element.

2. The method of claim 1, wherein the media item includes a Web page for a Question and Answer (Q&A) forum.

3. The method of claim 1, further comprising transmitting a request to a server to update the media item with the answer including the search-result reference, wherein the server provides a plurality of media items including the media item.

4. The method of claim 1, wherein the search-result reference comprises a footnote to the answer.

5. The method of claim 1, further comprising automatically executing the search request using a search Application Program Interface.

6. The method of claim 1, wherein the search-result reference includes a hyperlink to a Website identified by the search result.

7. The method of claim 1, wherein the associated graphical element comprises a first graphical element, further comprising removing the search-result reference in response to at least a user selection a second graphical element presented with the search-result reference.

8. The method of claim 1, wherein the associated graphical element comprises a graphical button.

9. The method of claim 1, wherein the media item comprises a first media item, further comprising:
presenting a second media item including the question, the answer, and the search-result reference for the answer, and the associated graphical element configured to the retrieve the search result; and
automatically retrieving the search result in response to at least a user selecting the graphical element.

10. The method of claim 9, the second media item comprises a Q&A Webpage.

11. Software for embedding a reference comprising computer readable instructions embodied on media and operable to:
presenting a media item including a question, a box for updating the media item with an answer, and a search field for entering a search query;
in response to at least a search request entered in the search field, automatically executing the search request with a remote search engine;
presenting a search result with an associated graphical element configured to update an answer to the question with a reference to the search result; and
automatically updating the answer including the search-result reference in response to at least a user selecting the associated graphical element.

12. The software of claim 11, wherein the media item includes a Web page for a Question and Answer (Q&A) forum.

13. The software of claim 11, the software further operable to transmit a request to a server to update the media item with the answer including the search-result reference, wherein the server provides a plurality of media items including the media item.

14. The software of claim 11, wherein the search-result reference comprises a footnote to the answer.

15. The software of claim 11, the software further operable to automatically execute the search request using a search Application Program Interface.

16. The software of claim 11, wherein the search-result reference includes a hyperlink to a Website identified by the search result.

17. The software of claim 11, wherein the associated graphical element comprises a first graphical element, the software further operable to remove the search-result reference in response to at least a user selection a second graphical element presented with the search-result reference.

18. The software of claim 11, wherein the associated graphical element comprises a graphical button.

19. The software of claim 11, wherein the media item comprises a first media item, the software further operable to:
present a second media item including the question, the answer, and the search-result reference for the answer, and the associated graphical element configured to the retrieve the search result; and
automatically retrieve the search result in response to at least a user selecting the graphical element.

20. The software of claim 19, the second media item comprises a Q&A Webpage.

21. A system for embedding references, comprising:
a means for presenting a media item including a question, a box for updating the media item with an answer, and a search field for entering a search query;
in response to at least a search request entered in the search field, a means for automatically executing the search request with a remote search engine;
a means for presenting a search result with an associated graphical element configured to update an answer to the question with a reference to the search result; and
a means for automatically updating the answer including the search-result reference in response to at least a user selecting the associated graphical element.
